(19) United States
(12) Patent Application Publication
(10) Pub. No.: US 2012/0044339 A1
(43) Pub. Date: Feb. 23, 2012

(54) OPTO-FLUIDIC MICROSCOPE SYSTEM WITH EVALUATION CHAMBERS

(76) Inventors: Curtis W. Stith, Santa Cruz, CA (US); Dmitry Bakin, San Jose, CA (US); Ulrich Boettiger, Boise, ID (US); Kenneth Edward Salsman, Pleasanton, CA (US)

(21) Appl. No.: 13/114,980

(22) Filed: May 24, 2011

Related U.S. Application Data
(60) Provisional application No. 61/439,684, filed on Feb. 4, 2011.
(60) Provisional application No. 61/375,227, filed on Aug. 19, 2010.

(51) Int. Cl. H04N 7/18

(52) U.S. Cl. 348/79; 348/E07.085

(57) ABSTRACT

An image sensor integrated circuit may contain image sensor pixels. A channel containing a fluid with particles such as cells may be formed on top of the image sensor. The image sensor pixels may form light sensors and imagers. The imagers may gather images of the cells or other particles as the fluid passes over the imagers. The channel may have multiple branches. Gating structures and other fluid control structures may control the flow of fluid through the channel branches. Portions of the channel may be used to form chambers. The chambers may each be provided with one or more light sensors, light sources, and color filters to alter the color of illumination form a light source, one or more reactants such as dyes, antigens, and antibodies, and heaters. The branches may route the fluid to respective chambers each of which has a different set of capabilities.

This application claims the benefit of provisional patent application No. 61/439,684, filed Feb. 4, 2011 and provisional patent No. 61/375,227, filed Aug. 19, 2010, which are hereby incorporated by reference herein in their entireties.

### BACKGROUND

This relates generally to systems such as opto-fluidic microscope systems, and, more particularly, to using such systems to image and evaluate fluid samples containing cells and other specimens.

Opto-fluidic microscopes have been developed that can be used to generate images of cells and other biological specimens. The cells are suspended in a fluid. The fluid flows over a set of image sensor pixels in a channel. The image sensor pixels may be associated with an image sensor pixel array that is masked using a metal layer with a pattern of small holes. In a typical arrangement, the holes and corresponding image sensor pixels are arranged in a diagonal line that crosses the channel. As cells flow through the channel, image data from the pixels may be acquired and processed to form high-resolution images of the cells.

### BRIEF DESCRIPTION OF THE DRAWINGS

FIG. 1 is a diagram of an illustrative system for imaging and evaluating cells and other biological specimens in accordance with an embodiment of the present invention.

FIG. 2 is a cross-sectional side view of a portion of an image sensor pixel array of the type that may be used in a fluid channel in a system of the type shown in FIG. 1 in accordance with an embodiment of the present invention.

FIG. 3 is a top view of an illustrative fluid channel having image pixels arranged in a line to form an imager in accordance with an embodiment of the present invention.

FIG. 4 is a cross-sectional diagram showing how image sensor pixels may be used to form a light sensor associated with a chamber in accordance with an embodiment of the present invention.

FIG. 5 is a top view of an illustrative system having multiple channels and multiple chambers in accordance with an embodiment of the present invention.

FIG. 6 is a cross-sectional end view of an illustrative chamber having an entrance port for receiving a sample in accordance with an embodiment of the present invention.

FIG. 7 is a cross-sectional end view of an illustrative chamber having a heater and a flow control electrode in accordance with an embodiment of the present invention.

FIG. 8 is a cross-sectional end view of an illustrative chamber having a light source and a reactant in accordance with an embodiment of the present invention.

FIG. 9 is a top view of an illustrative chamber showing how the chamber may be provided with regions having different reactant coatings or other individualized properties in accordance with an embodiment of the present invention.

FIG. 10 is a top view of an illustrative chamber showing how a reactant may be supplied from an ancillary chamber in accordance with an embodiment of the present invention.

FIG. 11 is a top view of an illustrative system in which a channel has multiple braches with multiple respective evaluation regions and in which controllable gate structures are used to control fluid flow within the system in accordance with an embodiment of the present invention.

FIG. 12 is a cross-sectional side view of a system in which a reactant is located at the beginning of a channel and in which an evaluation chamber is located at the end of the channel in accordance with an embodiment of the present invention.

FIG. 13 is a flow chart of illustrative steps involved in using a system with fluid channels and evaluation chambers to evaluate samples in accordance with an embodiment of the present invention.

### DETAILED DESCRIPTION

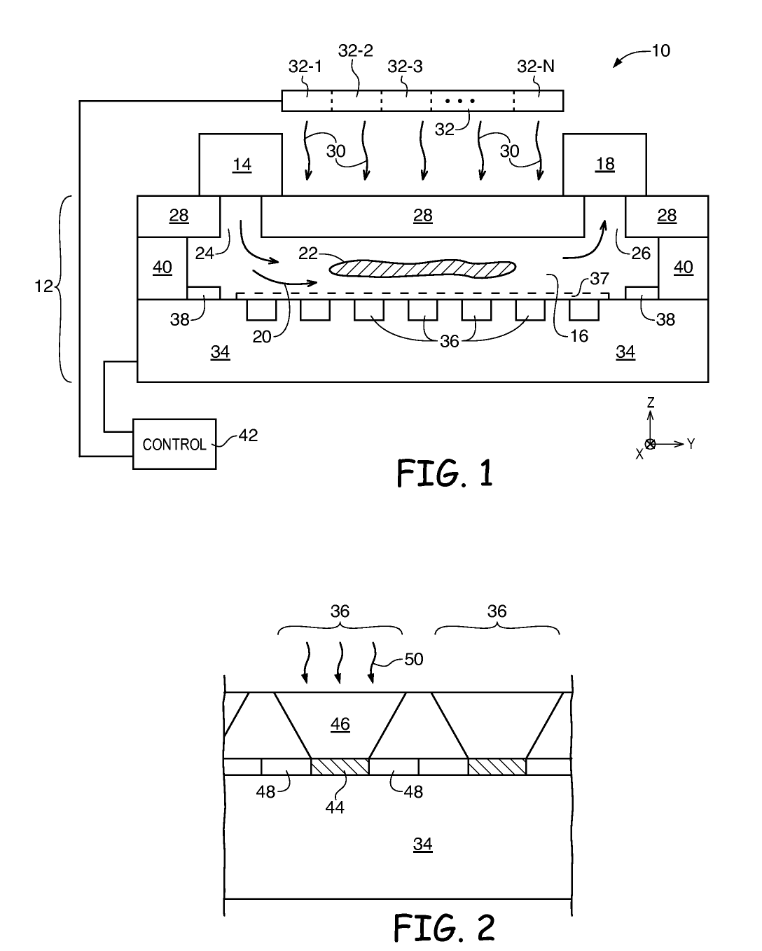

A system of the type that may be used to image and otherwise evaluate cells and other samples such as biological specimens is shown in FIG. 1. As shown in FIG. 1, system 10 may include opto-fluidic microscope 12. Microscope 12 may include an image sensor integrated circuit such as image sensor integrated circuit 34. Image sensor integrated circuit 34 may be formed from a semiconductor substrate material such as silicon and may contain numerous image sensor pixels 36. Complementary metal-oxide-semiconductor (CMOS) technology or other image sensor integrated circuit technologies may be used in forming image sensor pixels 36 and integrated circuit 34.

Image sensor pixels 36 may form part of an array of image sensor pixels on image sensor integrated circuit 34 (e.g., a rectangular array). Some of the pixels may be actively used for gathering light. Other pixels may be inactive or may be omitted from the array during fabrication. In arrays in which fabricated pixels are to remain inactive, the inactive pixels may be covered with metal or other opaque materials, may be depowered, or may otherwise be inactivated. There may be any suitable number of pixels fabricated in integrated circuit 34 (e.g., tens, hundreds, thousands, millions, etc.). The number of active pixels in integrated circuit 34 may be tens, hundreds, thousands, or more).

Image sensor integrated circuit 34 may be covered with a transparent layer of material such as glass layer 28 or other covering layers. Layer 28 may, if desired, be colored or covered with filter coatings (e.g., coatings of one or more different colors to filter light). Image sensor pixels 36 may be covered with color filter layer 37. Color filter layer 37 may be color filtering material formed individually on image sensor pixels 36 or applied as a flat planar coating covering the lower surface channel 16. Color filter layer 37 may include with red filters, portions with blue color filters, portions having green color filers, portions having tiled color filters (e.g., tiled Bayer pattern filters, etc.). If desired, color filter layer 37 may include infrared-blocking filters, ultraviolet light blocking filters, visible-light-blocking-and-infrared-passing filters, etc. Structures such as standoffs 40 (e.g., polymer standoffs) may be used to elevate the lower surface of glass layer 28 from the upper surface of image sensor integrated circuit 34. This forms one or more channels such as channels 16. Channels 16 may have lateral dimensions (dimensions parallel to dimensions x and z in the example of FIG. 1) of a millimeter or less (as an example). The length of each channel (the dimension of channel 16 along dimension y in the example of

FIG. 1) may be 1-10 mm, less than 10 mm, more than 10 mm, or other suitable length. Standoff structures 40 may be patterned to form sidewalls for channels such as channel 16.

During operation, fluid flows through channel 16 as illustrated by arrows 20. A fluid source such as source 14 may be used to introduce fluid into channel 16 through entrance port 24. Fluid may, for example, be dispensed from a pipette, from a drop on top of port 24, from a fluid-filled reservoir, from tubing that is coupled to an external pump, etc. Fluid may exit channel 16 through exit port 26 and may, if desired, be collected in reservoir 18. Reservoirs (sometimes referred to as chambers) may also be formed within portions of channel 16.

The rate at which fluid flows through channel 16 may be controlled using fluid flow rate control structures. Examples of fluid flow rate control structures that may be used in system 10 include pumps, electrodes, microelectromechanical systems (MEMS) devices, etc. If desired, structures such as these (e.g., MEMs structures or patterns of electrodes) may be used to form fluid flow control gates (i.e., structures that selectively block fluid flow or allow fluid to pass and/or that route fluid flow in particular directions). In the example of FIG. 1, channel 16 has been provided with electrodes such as electrodes 38. By controlling the voltage applied across electrodes such as electrodes 38, the flow rate of fluids in channel 16 such as ionic fluids may be controlled by control circuitry 42.

Fluid 20 may contain cells such as cell 22 or other biological elements or particles. As cells such as cells 22 pass by sensor pixels 36, image data may be acquired. In effect, the cell is “scanned” across the pattern of sensor pixels 36 in channel 16 in much the same way that a printed image is scanned in a fax machine. Control circuitry 42 (which may be implemented as external circuitry or as circuitry that is embedded within image sensor integrated circuit 34) may be used to process the image data that is acquired using sensor pixels 36. Because the size of each image sensor pixel 36 is typically small (e.g., on the order of 0.5-5.6 microns or less in width), precise image data may be acquired. This allows high-resolution images of cells such as cell 22 to be produced. A typical cell may have dimensions on the order of 1-10 microns (as an example). Images of other samples (e.g., other biological specimens) may also be acquired in this way. Arrangements in which cells are imaged are sometimes described herein as an example.

During imaging operations, control circuit 42 (e.g., on-chip and/or off-chip control circuitry) may be used to control the operation of light source 32. Light source 32 may be based on one or more lamps, light-emitting diodes, lasers, or other sources of light. Light source 32 may be a white light source or may contain one or more light-generating elements 32-1, 32-2, 32-3 . . . 32-N that emit different colors of light. For example, light-source 32 may contain multiple light-emitting diodes of different colors or may contain white-light light-emitting diodes or other white light sources that are provided with different respective colored filters. Light source 32 may be configured to emit laser light of a desired frequency or combination of frequencies. If desired, layer 28 and layer 37 may be implemented using colored transparent material in one or more regions that serve as one or more color filters. In response to control signals from control circuitry 42, light source 32 may produce light 30 of a desired color and intensity. Light 30 may pass through glass layer 28 to illuminate the sample in channel 16.

A cross-sectional side view of illustrative image sensor pixels 36 is shown in FIG. 2. As shown in FIG. 2, image sensor pixels 36 on integrated circuit 34 may each include a corresponding photosensitive element such as photodiode 44. Light guides such as light guide 46 may be used to concentrate incoming image light 50 into respective photodiodes 44. Photodiodes 44 may each convert incoming light into corresponding electrical charge. Circuitry 48, which may form part of control circuitry 42 of FIG. 1, may be used to convert the charge from photodiodes 44 into analog and/or digital image data. In a typical arrangement, data is acquired in frames. Control circuitry 42 may convert raw digital data from one or more acquired image data frames into images of cells 22.

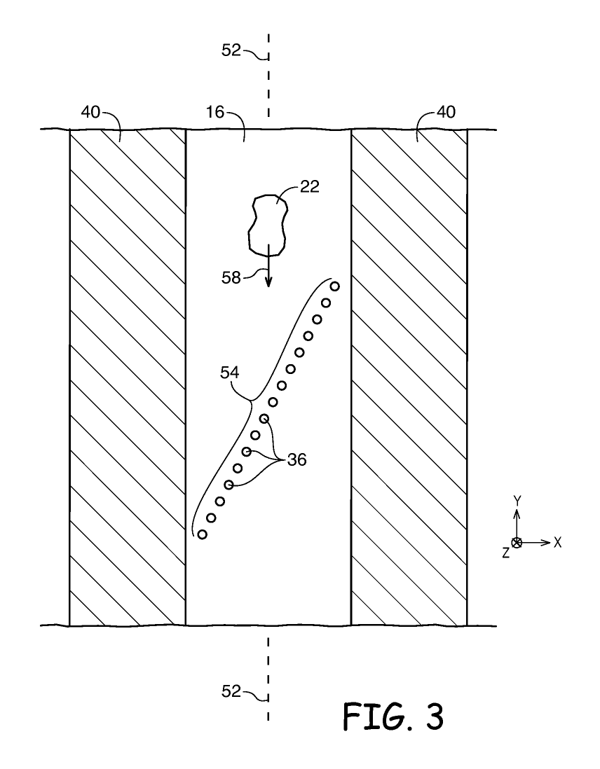

As shown in FIG. 3, pixels 36 in channel 16 may be arranged to form imager 54. Pixels 36 may be arranged in a diagonal line that extends across the width of channel 16 or may be arranged in other suitable patterns. The use of a diagonal set of image acquisition pixels 36 in channel 16 may help improve resolution (i.e., lateral resolution in dimension x perpendicular to longitudinal axis 52), by increasing the number of pixels 36 per unit length in dimension x. The image acquisition pixels 36 in channel 16 (i.e., the imager sensor pixels) are sometimes referred to as forming an image acquisition region, image sensor, or imager.

Light source 32 may be adjusted to produce one or more different colors of light during image acquisition operations. Channels 16 in system 10 may be provided with one or more imagers 54. The different colors of light may be used in gathering image data in different color channels. A different light color may be used in illuminating cells 22 as cells 22 pass respective imagers 54 in channel 16 by moving in direction 58 with the fluid in channel 16.

In some situations, it may be desirable to mix fluid 20 and/or cells 22 with a reactant. Examples of reactants that may be introduced into channel 16 with fluid 20 and cells 22 include diluents (e.g., fluids such as ionic fluids), dyes (e.g., fluorescent dyes) or other chemical compounds, biological agents such as antigens, antibodies (e.g., antibodies with dye), etc. With one suitable arrangement, one or more reactants may be introduced within a portion of channel 16. The portion of channel 16 that receives the reactant may be, for example, a portion of channel 16 that has been widened or a portion of channel 16 that has the same width as the rest of the channel. Portions of channel 16 (whether widened or having other shapes) that receive reactant or that may be used to introduce sample material into channel 16 are sometimes referred to herein as chambers.

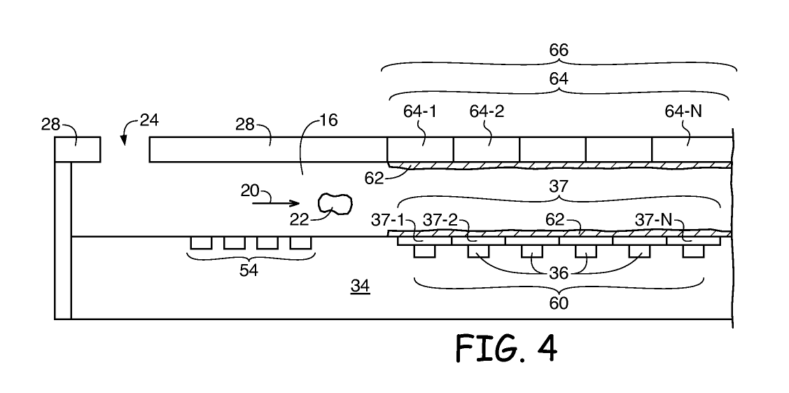

A cross-sectional side view of an illustrative system having a chamber that has been provided with reactant is shown in FIG. 4. In system 10 of FIG. 4, a fluid sample can be introduced into channel 16 on image sensor integrated circuit substrate 34 through entrance port 24 in glass layer 28. The fluid and associated particles within the fluid such as cell 22 may flow through channel 16 as illustrated by fluid flow arrow 20. Imager 54 may be used to gather images of cell 22 as cell 22 passes over imager 54.

Part of channel 16 may be used to form chamber 66. Chamber 66 may be provided with reactant such as reactant 62 and/or components for evaluating samples such as cell 22. As shown in FIG. 4, for example, reactant 62 such as a fluorescent dye or other reactant may be used to cover the lower surface and/or upper surface of chamber 66. The lower surface of chamber 66 (i.e., the lower surface of channel 16) may have a pattern of image sensor pixels 36 that form one or more light sensors (e.g., one or more light meters) such as light sensor 60. The image pixels that make up light sensor 60 may be used collectively (i.e., in a binned fashion) to improve noise performance and/or may be used individually (or in small groups associated with respective light sensors) to gather location-dependent light readings. Reactant 62 may be formed on or near the image sensor pixels 36 in chamber 66 and/or on the upper surface of channel 16 (as examples). When fluid and cells 22 reach chamber 66, reactant 62 may react with the fluid and/or cells. For example, dye in layers 62 may dye the cells.

In the illustrative configuration of FIG. 4, upper portion 64 of chamber 16 has been provided with elements 64-1, 64-2, . . . 64-N. Elements 64-1, 64-2, . . . 64-N may be transparent colored filter elements that are arranged in a tiled fashion over the upper surface of chamber 66. Each filter element may be used to filter light entering and/or exiting chamber 66. For example, each filter element may be used to filter a white light illumination source, thereby illuminating the interior of chamber 66 with various different types of colored light. The sample within chamber 66 (e.g., the fluid containing dyed cells or other sample particles) may respond differently to different colors of light. For example, the sample may fluoresce in response to illumination with one color of light but not in response to another. The use of different colors of light to illuminate different portions of the sample with different wavelengths of interest can therefore be useful in analyzing the sample. Filter elements 37-1, 37-2, . . . 37-N may also be used to filter light emissions from within chamber 66. Lower portion 37 of chamber 66 has been provided with elements 37-1, 37-2, . . . 37-N. Elements 37-1, 37-2, . . . 37-N may be transparent colored filter elements that are arranged in a tiled fashion over the upper surface of chamber 66. Each filter element may be used to filter light entering light sensor 60. For example, each filter element may be used to filter a white light illumination source, thereby illuminating the portions of light sensor 60 with various different types of colored light. The sample within chamber 66 (e.g., the fluid containing dyed cells or other sample particles) may respond differently to different colors of light. For example, the sample may fluoresce in response to illumination with one color of light but not in response to another. The collection of different colors of light using light sensor 60 can therefore be useful in analyzing the sample. Reactant 62 may be provided in a uniform coating over a sidewall, over a lower chamber surface, over an upper chamber surface, or in other suitable chamber regions. If desired, reactant 62 may be patterned. For example, some regions of a chamber may be coated with reactant and other regions of the chamber may be left uncoated. Different reactants may be provided in different regions (e.g., in a tiled pattern on the lower or upper surface of the chamber, etc.). Any suitable number of different reactants may be used within one chamber (e.g., one, two, three, four, more than four, etc.).

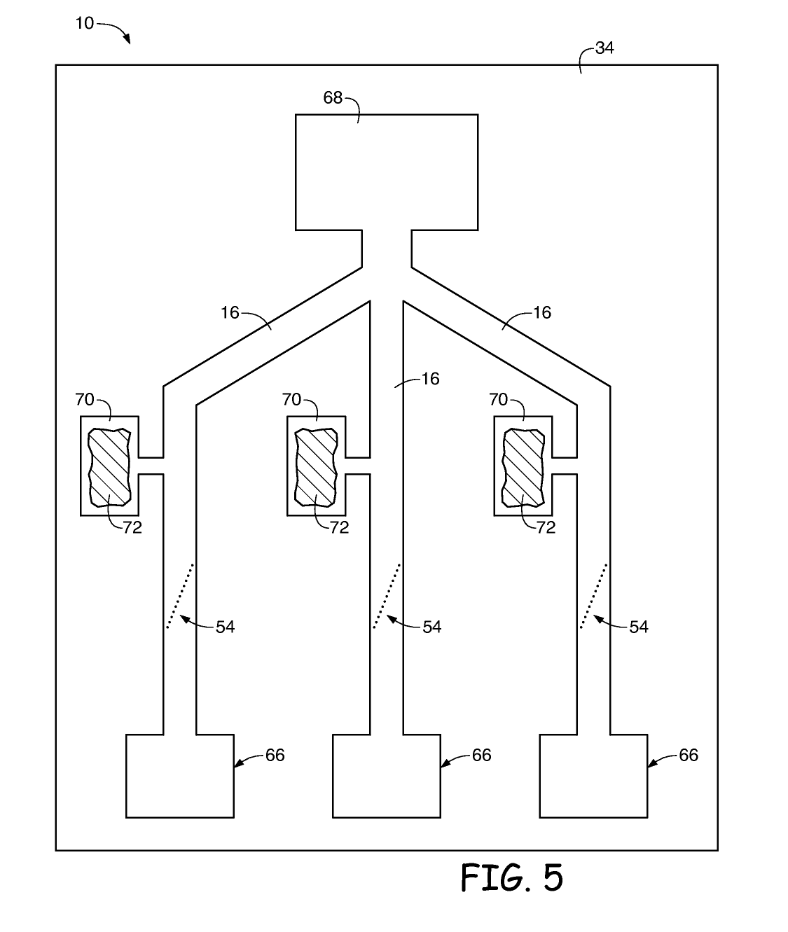

System 10 may have a channel pattern that routes fluid to multiple chambers 66. Different chambers may be used, for example, to make different types of measurements (e.g., using different reactants, different illumination sources, different colors of illumination, different temperatures, etc.). An illustrative configuration for system 10 that has multiple chambers 66 and channel branches on a single image sensor array substrate 34 is shown in FIG. 5. As shown in the illustrative arrangement of FIG. 5, system 10 may include a chamber such as chamber 68 that serves as an entrance port for channel structures 16. Channel structures 16 may include a channel that separates into multiple channel branches (i.e., channel structures 16 may include multiple interconnected channels). In the example of FIG. 5, channel structures 16 initially form a single channel at the exit of chamber 68. This single channel then splits into respective left, center, and right channel branches 16.

Channels 16 may be provided with chambers such as chambers 70. Chambers 70 may contain reactant 72. For example, chambers 70 may contain dilutant for diluting the sample flowing through each respective channel 16. Other reactants may be provided in chambers 70 if desired such as dyes or other chemical compounds, biological agents such as antigens, antibodies (i.e., antibodies with dye), etc.

Each channel branch 16 may have one or more imagers 54 for gathering image data on the sample. At the end of each channel branch 16, the sample may be evaluated using a respective evaluation chamber 66. Each chamber 66 may, if desired, be provided with different capabilities for evaluating the sample. For example, the chamber associated with the left channel in FIG. 5 may contain a first reactant, the chamber associated with the central channel in FIG. 5 may contain a second reactant, and the chamber associated with the right channel in FIG. 5 may contain a third reactant. The first, second, and third reactants may all be different. Each evaluation chamber may also contain additional reactants, may use different types of illumination, may use different light sensor schemes, and may otherwise have duplicative and/or independent capabilities from the other chambers in system 10.

With a multichannel arrangement of the type shown in FIG. 5, a sample may be evaluated using different types of tests in different chambers. In one chamber, for example, a dye or tiled pattern of dyes may be present and light and light sensors may be used to make fluorescence measurements, whereas different types of measurements using different dyes, light colors, illumination intensities, and/or different environmental characteristics such as different temperatures may be made in other chambers.

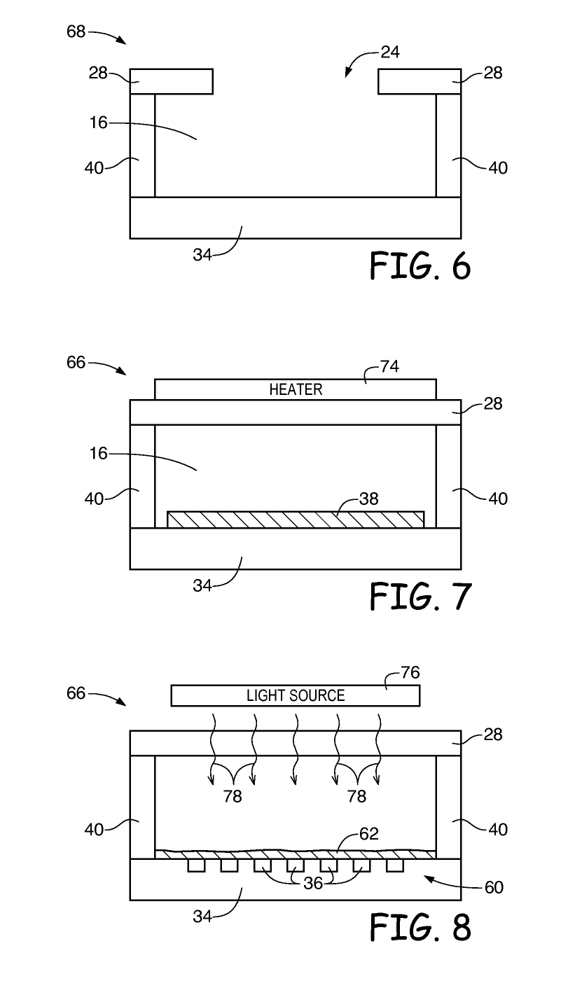

FIGS. 6, 7, and 8 are cross-sectional end views of illustrative types of chambers that may be used in implementing chambers in system 10. As shown in FIG. 6, entrance chamber 68 may contain an entrance port. Samples may be introduced into chamber 68 for distribution to an array of channels 16.

FIG. 7 shows how evaluation chamber 66 may be provided with a heater such as heater 74. Heater 74 may be, for example, a resistive heater that is controlled by control circuitry 42 (FIG. 1). During sample evaluation operations, heater 74 may be turned on and off to cycle the temperature in the interior of the chamber. Voltages may be applied to chambers such as chamber 66 of FIG. 7 using electrodes such as electrode 38. By controlling the voltages on electrodes 38 in chambers 66 and/or other channel structures in system 10, the flow of sample fluids such as ionic fluids may be controlled.

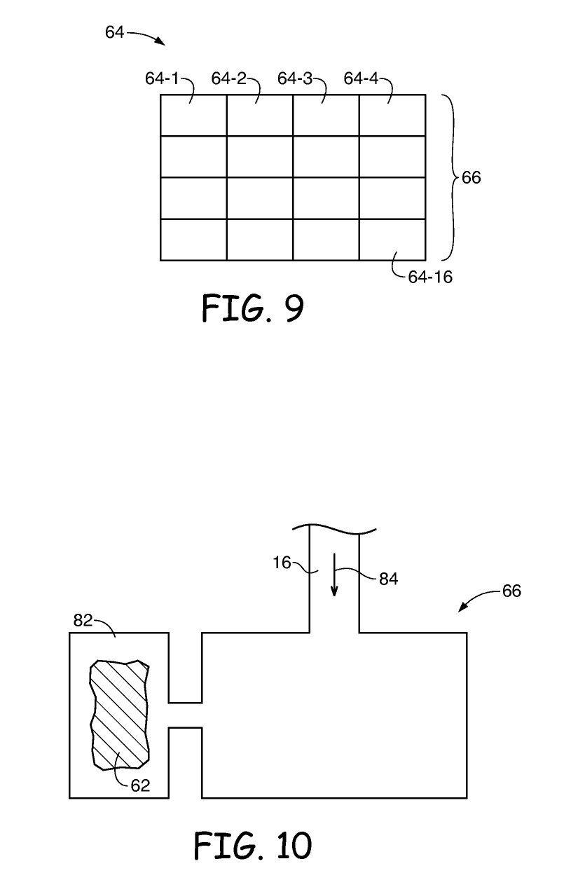

As shown in the example of FIG. 8, chamber 66 may be provided with a light source such as light source 76 that produces light 78 of one or more different colors (using optional color filters in light source 76 and/or light filters integrated into the upper surface of chamber 66 in a pattern of the type shown in FIG. 9). Reactant 62 may be provided on any of the exposed surfaces of chamber 66. In the FIG. 8 example, reactant 62 has been provided on a lower chamber surface (as an example). Image sensor pixels 36 may be used to form one or more image sensors 60. Image sensor pixels 36 of image sensors 60 may be configured to receive light of various colors (using optional color filters over image sensor pixels 36 or integrated into the lower surface of chamber 66).

As shown in the illustrative chamber top view of FIG. 9, chambers 66 may be provided with upper portions 64 that have a pattern (e.g., a tiled pattern) of different sub-portions such as 16 illustrative subportions 64-1, 64-2, . . . 64-16. Each subportion may be provided with a different colored filter element, a different reactant coating, etc.

FIG. 10 is a top view of an illustrative chamber structure for system 10 in which reactant 62 is introduced into chamber 66 from an ancillary chamber (chamber 82). Reactant 62 may be a diluent, a dye or other chemical compound, a biological agent such as an antigen, antibodies (i.e., antibodies with dye), or other substance that reacts with samples that flow through channel 16 into chamber 66 in direction 84.

Any or all of the features of chambers such as chamber 66 of FIGS. 4, 6, 7, 8, 9, and 10 may be combined to form one or more chambers 66 in system 10. For example, a chamber may be formed that has electrodes 38, reactant 62, light source 76, heater 74, image sensor 60, an ancillary chamber such as chamber 82 of FIG. 10, and patterned filters and/or patterned reactant that uses a pattern of the type shown in FIG. 9. The chamber layouts of FIGS. 4, 6, 7, 8, 9, and 10 are merely examples.

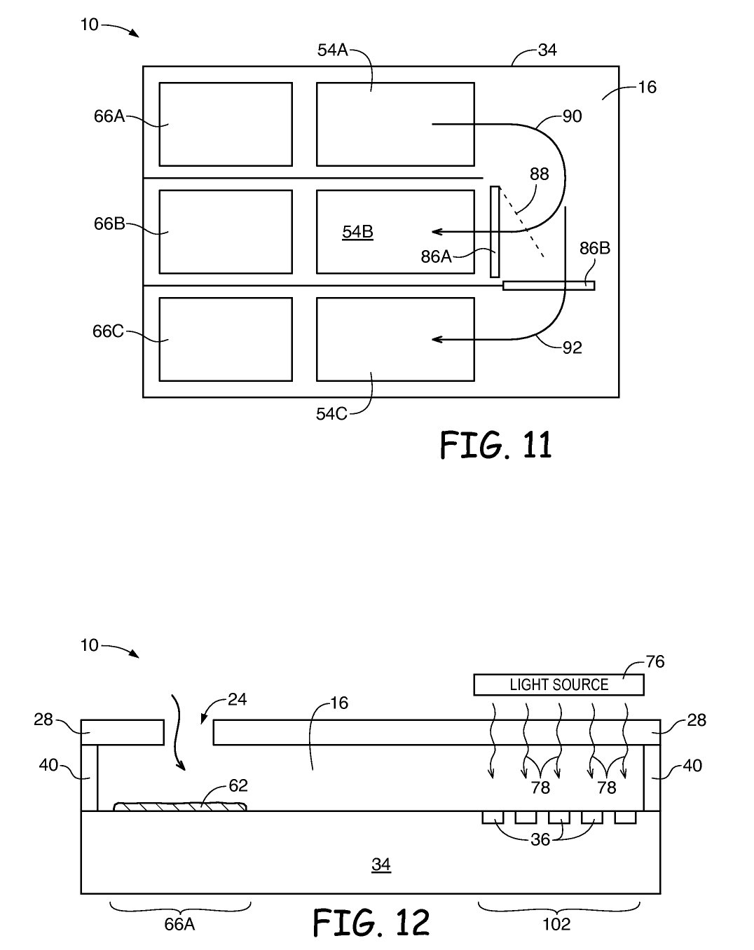

FIG. 11 shows how system 10 may have a rectilinear pattern of channels 16. In the arrangement of FIG. 11, channels are separated from each other by gate structures such as gate structures 86A and 86B. Gate structures 86A and 86B may, for example, be formed from MEMs structures, electrode-based structures, or other structures that can selectively permit fluid to flow or block fluid from flowing. Electrodes such as electrodes 38 of FIG. 1 or other fluid control mechanisms (e.g., MEMs structures, external pumps, etc.) may be used to cause the sample fluid to flow through channel 16. Gate structures 86A and 86B may be used to route the flow of the sample. When closed, gate structure 86A may prevent fluid from flowing in direction 90. When gate structure 86A is open (e.g., when gate structure 86A is in the open position represented by dashed line 88), fluid may flow along path 90. Gating structures 86A and 86B and other fluid flow control structures may be controlled by control circuitry 42. When it is desired to direct fluid to flow along path 90, gate structure 86A may be placed in its open position and gate structure 86B may be placed in its closed position. When it is desired to route fluid along path 92, gate structure 86A may be placed in its closed position and gate structure 86B may be placed in its open position.

Fluid routing structures such as one or more gate structures may be used to cause samples to flow into different chambers 66. For example, a sample may be introduced into channel 16 of FIG. 11 in the vicinity of evaluation chamber 66A. Following evaluation in chamber 66A, electrodes or other flow control mechanisms may be used to direct the sample to flow past imager 54A. Gate structures 86A and 86B may then be adjusted by control circuitry 42 to direct the sample to flow past imager 54B into chamber 66B and/or to flow past imager 54C into chamber 66C for evaluation. If desired, different patterns of channels, chambers, and gate structures may be used in evaluating samples. For example, channel 16 may be provided with additional branches, more or fewer chambers 66 may be used, etc.

FIG. 12 is a cross-sectional side view of an illustrative arrangement that may be used for system 10 in which reactant 62 is introduced near the beginning of channel 16 (i.e., in a location such as chamber 66A that is upstream from a channel region such as chamber 102). Chamber 102 may contain image sensor pixels 36 for forming an imager 54 and/or one or more sensors 60. Chamber 102 may also include a heater, a light source such as light source 76 for producing light 78, color filters, one or more regions of reactant, etc.

In general, system 10 may have a channel that contains one or more branches and optional features such as one or more regions that contain reactant, light sensors, imagers, heaters, gating structures and other fluid control structures (e.g., flow rate control structures), illumination devices, etc.

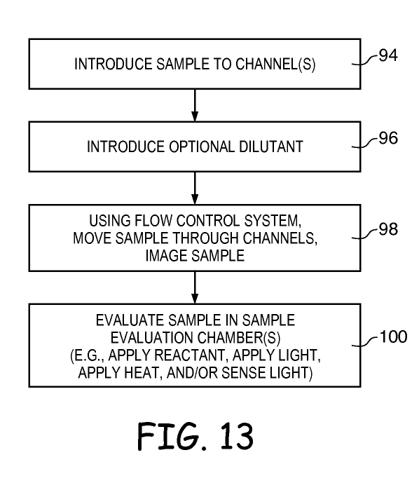

Illustrative steps involved in using system 10 to evaluate samples are shown in FIG. 13. At step 94, a sample of fluid such as a fluid containing cells or other particles may be introduced into channel 16 on image sensor array integrated circuit substrate 34. For example, a sample may be placed in a channel region such as chamber 68 of FIG. 5.

At step 96, optional dilutant may be combined with the sample to dilute the sample. For example, one or more dilutant chambers such as chambers 70 of FIG. 5 may be used to add dilutant to the sample. If desired, other reactants may be added to the sample during the operations of step 96. For example, dye, antigens, antibodies (e.g., antibodies with dye), or other reactants may be combined with the sample in channel 16 (e.g., using one or more reactant chambers such as chamber 66A of FIG. 12).

During the operations of step 98, the flow of the sample throughout the branches and other portions of channel 16 may be controlled using flow control structures such as electrodes 38, using gate structures such as gate structures 86A and 86B (FIG. 11), etc. For example, the sample may be routed to different branches of channel 16 and different chambers 66 as described in connection with FIG. 11. In a system that contains multiple parallel branches of channel 16 as described in connection with FIG. 5, the sample may be routed in parallel to different respective evaluation chambers 66.

At step 100, chambers 66 may be used to evaluate the sample. For example, reactant in chambers 66 (which may be provided using a tiled pattern of the type shown in FIG. 9 or in other suitable patterns) may react with the sample. One or more light sources such as light source 76 (and optionally color filters in layer 28) may be used to produce illumination for each chamber. The illumination may be provided in the form of white light or one or more different colors of light. Heaters such as heater 74 may be used to adjust the temperature of the sample during evaluation. The amount of light in chambers 66 may be evaluated using sensors 60. For example, following illumination with a light source, sensors 60 may be used to detect fluorescence signals. A checkerboard pattern or other tiled pattern may be used for color filters, sensors 60, and/or reactant within each chamber to allow information on the response of the sample to different colors and/or reactants to be measured. The data that is gathered during step 100 may be gathered and processed using control circuitry 42 (as an example).

Various embodiments have been described illustrating apparatus for imaging and evaluating samples of fluids containing cells and other materials. An integrated circuit such as an image sensor array integrated circuit may be provided with fluid channels. Sets of image sensor pixels from an image sensor array on the integrated circuit may form imagers in the fluid channels. A sample may be introduced into a channel for imaging by the imagers and for evaluation using other sample evaluation structures. Chambers may be provided for adding dilutant and other reactants such as dyes, antigens, antibodies, chemical compounds, and other materials to the sample fluid. The channel structures on the integrated circuit may have multiple branches. Flow control structures such as electrodes and gate structures such as microelectromechanical systems (MEMs) gate structures may be used to route fluid through various branches in the channel. For example, flow control structures may be used to route a sample to one or more different chambers for evaluation. Chambers in the channel may include reactant for reacting with the sample, a light source for providing illumination for the sample, a heater for heating the sample, and image sensor pixels. The image sensor pixels may be used in forming one or more light sensors in each chamber.

The foregoing is merely illustrative of the principles of this invention which can be practiced in other embodiments.

What is claimed is:

1. Apparatus, comprising:
an image sensor integrated circuit containing image sensor pixels that form at least one imager;
a fluid channel on the image sensor integrated circuit that is configured to receive fluid, wherein the at least one imager is located in the channel; and
at least one evaluation chamber coupled to the channel that contains reactant.

2. The apparatus defined in claim 1 wherein the evaluation chamber comprises part of the channel and contains multiple different reactants.

3. The apparatus defined in claim 1 further comprising a light source that illuminates the evaluation chamber.

4. The apparatus defined in claim 3 further comprising a heater that heats the evaluation chamber.

5. The apparatus defined in claim 4 further comprising at least one light sensor in the evaluation chamber, wherein the light sensor is formed from image sensor pixels contained in the image sensor integrated circuit.

6. The apparatus defined in claim 5 further comprising multiple color filters in the evaluation chamber, wherein the multiple color filters are arranged in a tiled pattern over the at least one light sensor.

7. The apparatus defined in claim 6 wherein the light source comprises multiple light-generating elements, wherein the multiple light-generating elements are configured to emit multiple corresponding colors of light.

8. The apparatus defined in claim 7 wherein the multiple reactants are arranged in a tiled pattern in the evaluation chamber.

9. The apparatus defined in claim 1 wherein the at least one reactant includes at least one reactant selected from the group consisting of: dilutant, dye, antigens, and antibodies.

10. The apparatus defined in claim 1 wherein the at least one reactant comprises multiple different dyes.

11. The apparatus defined in claim 10 further comprising:
a light source that illuminates the sample in the evaluation chamber; and
at least one light sensor in the evaluation chamber formed from image sensor pixels contained within the image sensor integrated circuit.

12. The apparatus defined in claim 1 wherein the channel contains multiple branches.

13. The apparatus defined in claim 12 wherein the at least one evaluation chamber comprise a plurality of evaluation chambers each of which is associated with a respective one of the branches.

14. The apparatus defined in claim 13 further comprising at least some gate structures that control fluid flow between the branches.

15. Apparatus, comprising:
an image sensor integrated circuit containing image sensor pixels that form at least one imager;
a fluid channel on the image sensor integrated circuit that is configured to receive a sample of fluid, wherein the at least one imager is located in the channel and is configured to acquire image data on biological specimens in the sample of fluid; and
at least one reactant in a portion of the fluid channel, wherein the reactant is selected from the group consisting of: dyes, antigens, and antibodies.

16. The apparatus defined in claim 15 wherein the portion of the fluid channel is configured to form an evaluation chamber and wherein the evaluation chamber comprises at least one light sensor formed from image sensor pixels on the image sensor integrated circuit.

17. The apparatus defined in claim 16 wherein the at least one reactant comprise a tiled pattern of multiple different reactants in the evaluation chamber.

18. Apparatus, comprising:
an image sensor integrated circuit containing image sensor pixels;
a plurality of interconnected channels on the image sensor integrated circuit that are configured to receive a sample of fluid, wherein the image sensor pixels are configured to form a plurality of imagers, wherein each of the imagers is contained within a different respective one of the interconnected channels; and
a plurality of light sensors each light sensor being formed from at least one image pixel on the image sensor integrated circuit, wherein the interconnected channels are configured to distribute the sample of fluid to each of the plurality of light sensors after the fluid has passed over at least one of the imagers.

19. The apparatus defined in claim 18 further comprising a light source adjacent to each of the light sensors.

20. The apparatus defined in claim 19 further comprising dye in the channels that dyes cells in the fluid, wherein the light sources generate illumination that causes the dyed cells to fluoresce and wherein the light sensors are configured to receive light from the dyed cells as the dyed cells fluoresce.
